(19) United States
(12) Patent Application Publication
(10) Pub. No.: US 2011/0069001 A1
(43) Pub. Date: Mar. 24, 2011

(54) ELECTRONIC PAPER DISPLAY DEVICE AND METHOD OF MANUFACTURING THE SAME

(75) Inventors: Hwan-Soo Lee, Seoul (KR); Yongsoo Oh, Seongnam (KR); Sang Moon Lee, Seoul (KR); Young Woo Lee, Suwon (KR); Hye Yeon Cha, Yongin (KR); Jeong Bok Kwak, Suwon (KR)

(73) Assignee: SAMSUNG ELECTRO-MECHANICS CO., LTD.

(21) Appl. No.: 12/693,941

(22) Filed: Jan. 26, 2010

(30) Foreign Application Priority Data
Sep. 18, 2009 (KR) 10-2009-0088740

(51) Int. Cl. G09G 3/34; B05D 5/12

(52) U.S. Cl. 345/107; 427/74

(57) ABSTRACT

An electronic paper display device includes: a display-side electrode disposed at a display side and formed of a transparent material; a back electrode disposed to face the display-side electrode; a substrate provided as a single layer disposed between the display-side electrode and the back electrode and including a plurality of first and second micro cups which are arranged in a two-dimensionally close-packed manner such that one micro cup is surrounded by different adjacent micro cups; and a plurality of first and second optical anisotropic elements disposed in the first and second micro cups, respectively, and having an optical characteristic changing in response to an electromagnetic change and a different driving voltage to change the optical characteristic.

### CROSS-REFERENCE TO RELATED APPLICATIONS

This application claims the priority of Korean Patent Application No. 10-2009-0088740 filed on Sep. 18, 2009, in the Korean Intellectual Property Office, the disclosure of which is incorporated herein by reference.

### BACKGROUND OF THE INVENTION

1. Field of the Invention

The present invention relates to an electronic paper display device, and more particularly, to an electronic paper display device which has a high contrast ratio and is capable of guaranteeing a low driving voltage, and a method of manufacturing the same.

2. Description of the Related Art

Recently, with the increasing development of mobile terminals and information communication networks, the demand for devices having excellent portability characteristics is increasing. A great deal of attention is being paid to electronic paper display devices as display devices which may satisfy such demand.

Since electronic paper display devices may have flexibility, they are easy to carry and handle. Furthermore, the electronic paper display devices may be driven by a low voltage, may maintain a clear screen even after power is cut off, and may provide a high resolution and a wide viewing angle.

The technical approach to the realization of electronic paper display paper may be accomplished using liquid crystals, organic electro luminescence (EL) displays, reflective film reflection-type displays, electrophoretic displays, or electrochromic displays.

In the method using electrophoretic capsules or twist balls, a single-layer structure is converted into a multilayer arrangement structure to implement a more close-packed arrangement, thereby obtaining a higher contrast ratio.

However, since such a multilayer structure may cause a result in which a distance between electrodes increases, a voltage required for diving capsules or balls may increase relatively. Further, since it is difficult to control the respective capsules or balls with a uniform driving voltage, the distribution of a driving voltage for each pixel may increase.

### SUMMARY OF THE INVENTION

An aspect of the present invention provides an electronic paper display device which has a monolayer structure to reduce a driving voltage and a high contrast ratio through a close-packed arrangement.

Another aspect of the present invention provides a method of manufacturing an electronic paper display device which reduces a driving voltage, implements a high contrast ratio through a close-packed arrangement, and may simplify the manufacturing process.

According to an aspect of the present invention, there is provided an electronic paper display device including: a display-side electrode disposed at a display side and formed of a transparent material; a back electrode disposed to face the display-side electrode; a substrate provided as a single layer disposed between the display-side electrode and the back electrode and including a plurality of first and second micro cups which are arranged in a two-dimensionally close-packed manner such that one micro cup is surrounded by different adjacent micro cups; and a plurality of first and second optical anisotropic elements disposed in the first and second micro cups, respectively, and having an optical characteristic changing in response to an electromagnetic change and a different driving voltage to change the optical characteristic.

The plurality of first and second micro cups may have the same size and are arranged in a plurality of lines such that a predetermined distance is provided between the respective lines, and the line arrangements of the first and second micro cups may be alternately repeated in such a manner that the position of a first micro cup is offset by a distance equal to half of the cup size from the position of a second micro cup adjacent to the first micro cup.

The plurality of first and second micro cups may have a periodic square-lattice arrangement in which one micro cup is positioned substantially in the center of a square lattice formed by different adjacent micro cups.

The second optical anisotropic element may have a smaller size than the first optical anisotropic element. The second micro cup may have a smaller size than the first micro cup.

The depth of the second micro cup may be less than that of the first micro cup.

The second micro cup may have such a small size so as not to contain the first optical anisotropic element.

According to another aspect of the present invention, there is provided an electronic paper display device including: a display-side electrode disposed at a display side and formed of a transparent material; a back electrode disposed to face the display-side electrode; a plurality of embossed patterns disposed as a single layer disposed between the display-side electrode and the back electrode and arranged in a two-dimensionally close-packed manner to provide first and second spaces which are regularly repeated; and a plurality of first and second optical anisotropic elements disposed in the first and second spaces, respectively, and having an optical characteristic changing in response to an electromagnetic change and a different driving voltage to change the optical characteristic.

According to another aspect of the present invention, there is provided a method of manufacturing an electronic paper display device, including: forming a back electrode on a base member; providing a substrate having a single layer structure on the back electrode; forming a plurality of first and second micro cups in the substrate, the first and second micro cups being arranged in a two-dimensionally close-packed manner such that one micro cup is surrounded by different adjacent micro cups; disposing first and second anisotropic elements in the first and second micro cups, respectively, the first and second anisotropic elements having an optical characteristic changing in response to an electromagnetic change and a different driving voltage in order to change the optical characteristic; and forming a display-side electrode formed of a transparent material on the substrate such that the display-side electrode faces the back electrode.

The disposing of the first and second optical anisotropic elements may include disposing the first optical anisotropic elements in the first micro cups using a first mask which opens only the first micro cups, and disposing the second optical anisotropic elements in the second micro cups using a second mask which opens only the second micro cups.

The second optical anisotropic element may have a smaller size than the first optical anisotropic element. The second micro cup may have a smaller size than the first micro cup. The second micro cup may be formed to have such a small size so as not to contain the first optical anisotropic element.

The disposing of the first and second optical anisotropic elements may include providing the first optical anisotropic elements on the substrate to dispose in the first micro cups, respectively, and providing the second optical anisotropic elements on the substrate to dispose in the second micro cups, respectively.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a top plan view of a substrate which may be adopted in an electronic paper display device according to an embodiment of the present invention;

FIGS. 2A to 2C are side cross-sectional views of the electronic paper display device according to the embodiment of the present invention, taken in different directions;

FIG. 3 is a graph showing drive characteristics of anisotropic elements depending on applied voltages in the electronic paper display device according to the embodiment of the present invention;

FIG. 4 is a top plan view of a substrate which may be adopted in an electronic paper display device according to another embodiment of the present invention;

FIG. 5 is a side cross-sectional view of the electronic paper display device according to the embodiment of the present invention, taken along a line B-B′ of FIG. 4;

FIG. 6 is a graph showing drive characteristics of anisotropic elements depending on applied voltages in the electronic paper display device according to the embodiment of the present invention;

FIGS. 7A to 7D are cross-sectional views explaining a method of manufacturing an electronic paper display device according to another embodiment of the present invention;

FIG. 8 is a top plan view of a substrate which may be adopted in an electronic paper display device according to another embodiment of the present invention; and

FIG. 9 is a side cross-sectional view of the electronic paper display device according to the embodiment of the present invention, taken along a line C-C′ of FIG. 8;

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and thus their description will be omitted.

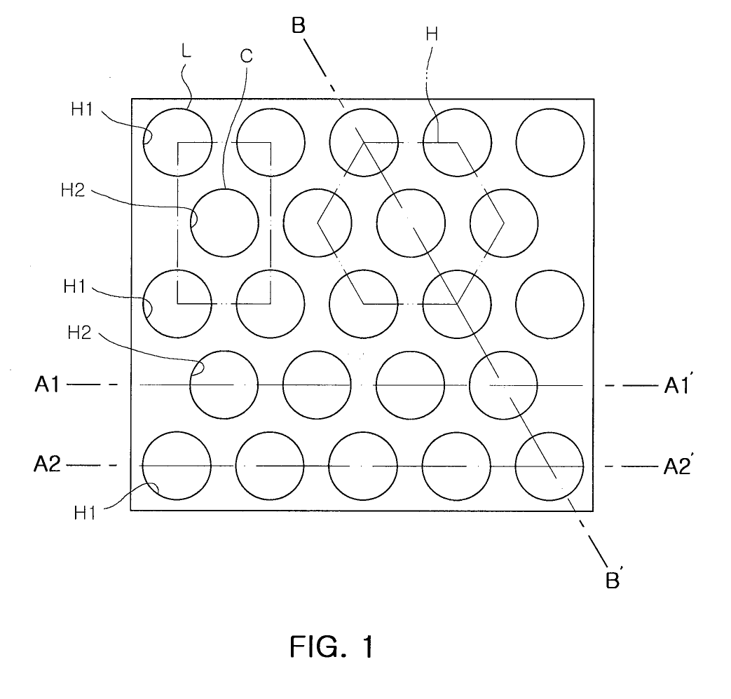

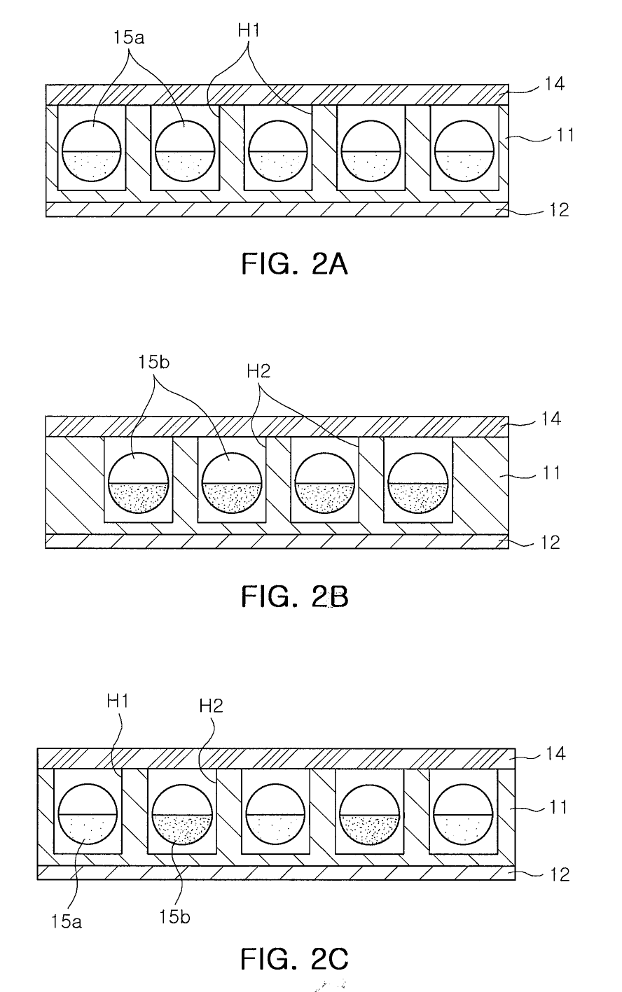

FIG. 1 is a top plan view of a substrate which may be adopted in an electronic paper display device according to an embodiment of the present invention. FIGS. 2A to 2C are side cross-sectional views of the electronic paper display device according to the embodiment of the present invention, taken in different directions.

Referring to FIGS. 1 and 2A to 2C, the electronic paper display device according to this embodiment of the present invention includes a display-side electrode 14 formed of a transparent conductive material, a back electrode 12 facing the display-side electrode 14, and a substrate 11 disposed between the display-side electrode 14 and the back electrode 12.

Referring to FIG. 1, the substrate 11 has a plurality of first and second micro cups H1 and H2 for containing optical anisotropic particles 15a and 15b having a different drive characteristic. Specifically, the first optical anisotropic particles 15a are disposed in the first micro cups H1, and the second optical anisotropic particles 15b are disposed in the second micro cups H2 (refer to FIGS. 2A to 2C).

The substrate 11 used in the embodiment of the present invention has a single-layer structure in which the first and second micro cups H1 and H2 are arranged in a two-dimensionally close-packed pattern.

To implement such a close-packed arrangement, one micro cup (for example, the first micro cup) may be disposed to be surrounded by different adjacent micro cups (for example, the second micro cup).

As in this embodiment, when the first and second micro cups H1 and H2 have the same size, the plurality of first and second micro cups H1 and H2 are arranged in a plurality of lines such that a constant distance is provided between the respective lines. Therefore, as illustrated in FIG. 2A, the first optical anisotropic elements may be disposed in the first micro cups positioned along a direction indicted by a line A1-A1′ of FIG. 1. Furthermore, as illustrated in FIG. 2B, the second optical anisotropic elements may be disposed in the second micro cups positioned along a direction indicated by a line A2-A2′ of FIG. 1.

Furthermore, referring to FIG. 1, the line arrangements of the first and micro cups H1 and H2 are alternately repeated in such a manner that the position of a first micro cup H1 is offset by a distance equal to half of the cup size from the position of a second micro cup H2 adjacent to the first micro cup H1. Such line arrangements may implement an arrangement in which the first and second micro cups containing the first and second optical anisotropic elements, respectively, are alternately disposed in a direction indicated by a line B-B′ of FIG. 1.

In such an arrangement, a specific second micro cup C may be disposed in a rectangular lattice L formed by the first micro cups H1 adjacent to the second micro cup C, as illustrated in FIG. 1.

In the arrangement of the first and second micro cups H1 and H2 according to this embodiment of the present invention, the first and second optical anisotropic elements may be repetitively arranged in a predetermined pattern. Such an arrangement may be understood as a form in which a hexagonal close-packed pattern H is repeated.

As such, the close-packed arrangement of the respective micro cups 15a and 15b may be implemented with a barrier rib interposed therebetween, the barrier rib having a constant and small thickness. Therefore, it is possible to increase a contrast ratio. Furthermore, since the substrate is implemented as a single layer, a distance between the electrodes 12 and 14 may be reduced, and a relatively low driving voltage may be expected.

In this embodiment, the first and second optical anisotropic elements 15a and 15b refer to an element whose optical characteristic changes in response to an electromagnetic change. Examples of the optical anisotropic element may include an electrophoretic microcapsule and a twist ball.

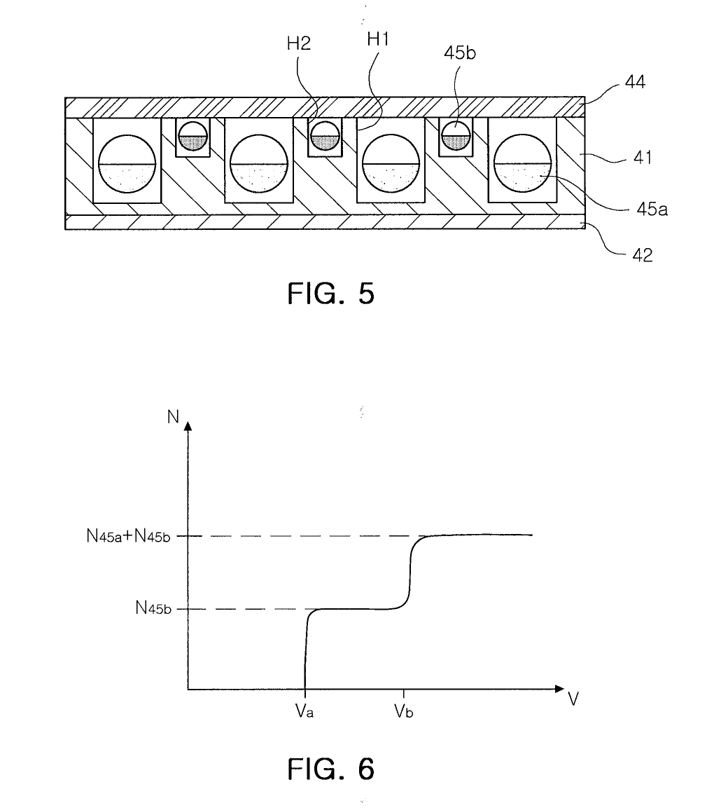

The first and second optical anisotropic elements 15a and 15b adopted in this embodiment have a different driving voltage to change the optical characteristic. As such, different drive characteristics may be obtained by various methods. For example, an electrolyte component and/or a surface charge related to the optical anisotropic elements may be treated in a different manner to obtain optical anisotropic elements having different drive characteristics. Furthermore, a method of diversifying the size (that is, diameter) of microcapsules or twist balls may be used separately from or together with the above-described method (refer to FIG. 5).

Therefore, the first and second optical anisotropic elements 15a and 15b may be selectively driven depending on the voltages applied from the electrodes 11 and 14.

In a specific embodiment, the first optical anisotropic element 15a may be designed to have a higher driving voltage V2 than a driving voltage V1 of the second optical anisotropic element 15b. In this case, when the voltage V1 is applied as illustrated in FIG. 3, the optical characteristic of the second optical anisotropic element 15b changes. Subsequently, when the voltage V2 is applied, the optical characteristic of the first optical anisotropic element 15a also changes with the second optical anisotropic element 15b.

Such a selective drive may be utilized for implementing additional functions. For example, optical anisotropic element groups having different drive characteristics may be implemented to have different color characteristics. Then, a function of controlling color characteristics depending on voltage selection may be additionally implemented.

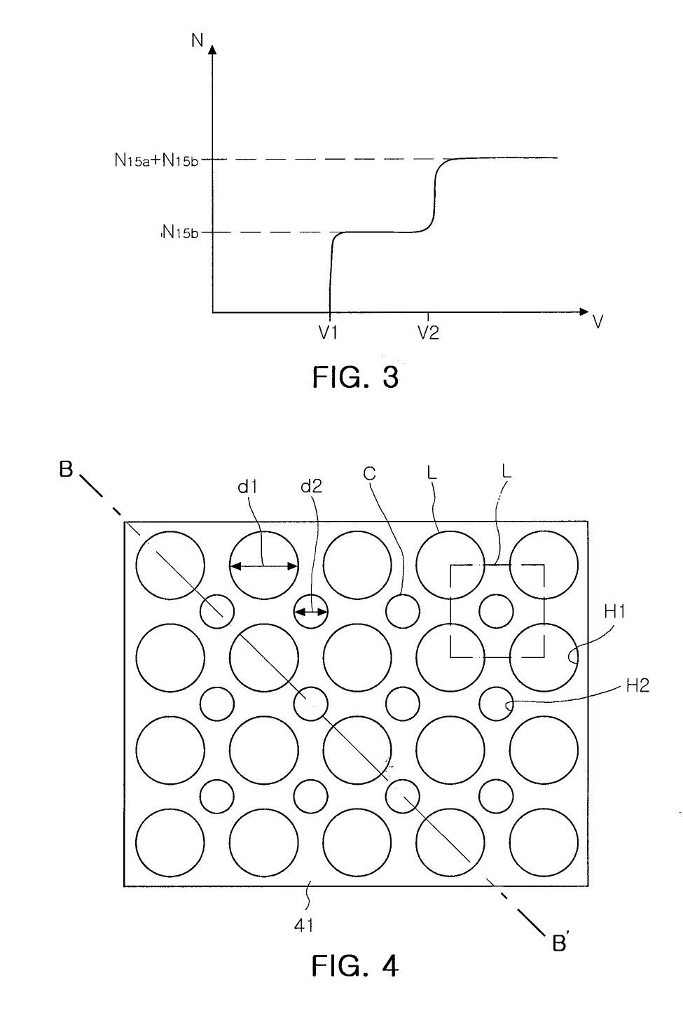

In the above embodiment, it has been described that the first and second optical anisotropic elements have the same size. Referring to FIGS. 4 and 5, however, an electronic paper display device according to another embodiment of the present invention includes optical anisotropic particles (for example, capsules or twist balls) having different sizes.

Referring to FIGS. 4 and 5, the electronic paper display device according to the embodiment of the present invention includes a display-side electrode 44 formed of a transparent conductive material, a back electrode 42 facing the display-side electrode 44, and a substrate 41 disposed between the display-side electrode 44 and the back electrode 42.

The substrate 41 has a plurality of first and second micro cups H1 and H2 for containing first and second optical anisotropic particles 45a and 45b. The first and second optical anisotropic particles 45a and 45b adopted in this embodiment have a different size. Thus, the first and second optical anisotropic particles 45a and 45b may have a different drive characteristic.

The first and second micro cups H1 and H2 formed in the substrate 41 used in this embodiment may have a different size from each other unlike those illustrated in FIG. 1, in order to contain the first and second optical anisotropic particles 45a and 45b having a different size.

That is, the first micro cup H1 containing the first optical anisotropic particle 45a with a large size has a larger diameter d1 than the diameter d2 of the second micro cup H2 containing the second optical anisotropic particle 45b with a small size.

The substrate 41 of this embodiment also has a single-layer structure, similar to the above-described embodiment. However, the first and second micro cups H1 and H2 may be arranged in a form similar to a three-dimensional arrangement such that the first and second optical anisotropic particles 45a and 45b are arranged in a more close-packed manner.

More specifically, the depth of the second micro cup H2 having a relatively small size may be less than that of the first micro cup H1 having a relatively large size, as illustrated in FIG. 5.

As such, the first and second optical anisotropic particles adopted in this embodiment of the present invention have a different size. Therefore, the first and second optical anisotropic particles may not only have a different drive characteristic, but interstitials between the respective particles having a large size may be effectively utilized to implement a more close-packed arrangement.

That is, interstitials between the respective particles having a relatively large size may be utilized to dispose micro cups in which the small particles are positioned. Then, it is possible to implement a more close-packed arrangement, as illustrated in FIG. 4.

In this embodiment, the plurality of micro cups H1 and H2 have a periodic square-lattice arrangement. In such an arrangement, one micro cup is positioned substantially in the center of a square lattice L formed by the adjacent micro cups having a different size. However, the arrangement is not limited thereto.

For example, the first micro cups may be arranged in a hexagonal close-packed pattern (refer to the entire arrangement of the first and second micro cups illustrated in FIG. 1), and each of the second micro cups may be disposed in an interstitial among three first micro cups forming a triangle lattice.

In this embodiment, it is possible to increase packing density as much as more than 10%, compared with a typical arrangement of the first optical anisotropic elements 45a using the first micro cups H1. Therefore, a contrast ratio may be improved more effectively. Further, since the basic structure with a single layer is maintained as it is, it is possible to expect a relatively low driving voltage.

Furthermore, since the first and second optical anisotropic elements 45a and 45b are contained in different micro cups so as to be spatially separated from each other, it is possible to prevent the elements from adhering to each other through the contact between the particles or interfering with each other when driven.

In this embodiment, the first optical anisotropic element 45a having a relatively large size may require a large driving voltage than the second optical anisotropic element 45b. Therefore, they may be selectively driven depending on voltages applied from the electrodes 41 and 44.

Referring to FIG. 6, when a voltage Va is applied, the optical characteristic of the second optical anisotropic element 45b changes. Subsequently, when a voltage Vb is applied, the optical characteristic of the first optical anisotropic element 45a also changes with the second optical anisotropic element 45b. For example, when the first and second optical anisotropic elements 45a and 45b have a different color characteristic, it is possible to control their color depending on the voltages.

Hereinafter, a method of manufacturing an electronic paper display device according to another embodiment of the present invention will be described. The method may start with a process of forming a back electrode on a base member. The back electrode may be implemented as an electric field application unit or a matrix address electrode which enables optical anisotropic particles contained in micro cups to be driven independently.

Then, a substrate with a single-layer structure is provided on the back electrode, and a plurality of first and second micro cups are formed in the substrate so as to be arranged in a two-dimensionally close-packed manner. In such an arrangement, one cup is surrounded by different adjacent micro cups. FIGS. 1 and 4 illustrate such a substrate structure.

Subsequently, first and second optical anisotropic elements having a different driving voltage to change an optical characteristic are disposed in the first and second micro cups, respectively. A display-side electrode composed of a transparent material is formed on the substrate so as to face the back electrode.

The disposing of the first and second optical anisotropic elements may include disposing the first optical anisotropic elements in the first micro cups using a first mask which opens only the first micro cups and disposing the second optical anisotropic elements in the second micro cups using a second mask which opens only the second micro cups.

As such, the mask or filter which selectively opens the formed micro cups may be disposed to selectively supply the respective optical anisotropic particles using a squeezer or the like. Then, a desired arrangement may be implemented.

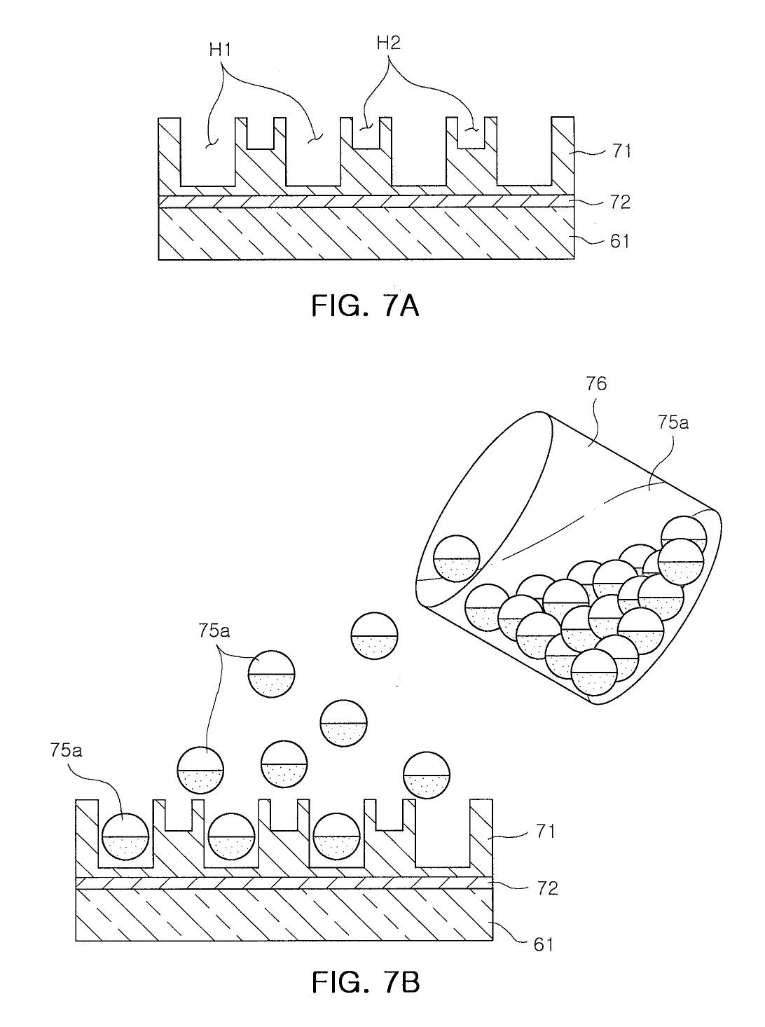

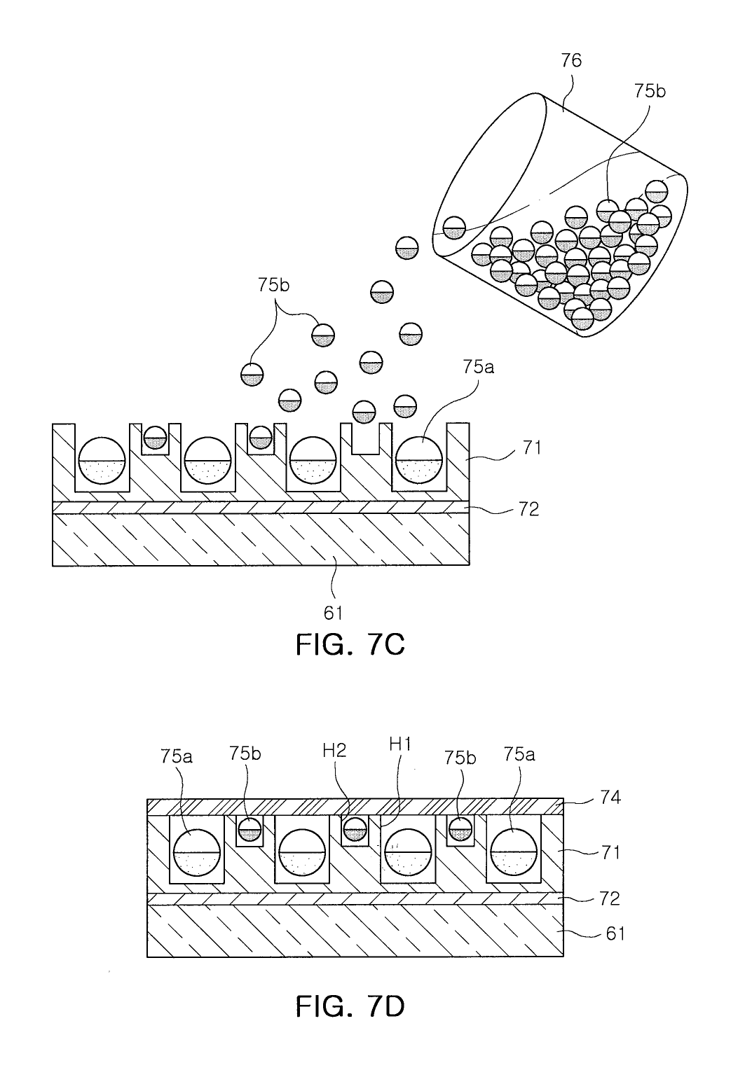

On the other hand, the embodiment illustrated in FIGS. 4 and 5, in which the balls and the micro cups have a different size, may be implemented by a simplified process. Such a process may be described with reference to FIGS. 7A to 7D.

First, referring to FIG. 7A, a substrate 71 is prepared on a base member 61 having a back electrode 72 formed thereon. Then, a plurality of first and second micro cups H1 and H2 are formed in the substrate 71. The first and second micro cups H1 and H2 are arranged in a two-dimensionally close-packed manner such that each of the first micro cups H1 is surrounded by the adjacent second micro cups H2 and each of the second micro cups H2 is surrounded by the adjacent first micro cups H1. In the substrate adopted in this embodiment of the present invention, the first and second micro cups H1 and H2 having a different size are adopted to contain balls having a different size, as illustrated in FIGS. 4 and 5.

Subsequently, first and second optical elements having a different driving voltage to change an optical characteristic are disposed in the first and second micro cups, respectively. Then, a display-side electrode composed of a transparent material is formed on the substrate so as to face the back electrode.

In a specific embodiment, the substrate may be provided by applying liquid resin onto a base member to a thickness of 100-200 μm, the base member having a back electrode formed of a thin metallic film or thin metallic film pattern. Such an application process may be performed using a doctor blade or die coater.

Subsequently, first and second micro cups H1 and H2 having a different size are formed by imprinting, laser drilling, lithography, or sand blasting.

The process of disposing the first and second optical anisotropic elements (capsules or balls) in the respective micro cups may be simply performed by using a difference in cup size or a difference in capsule or ball size without using a mask which selectively opens the micro cups.

In order for the simplification of the process, the second micro cup H2 may have such a size as to contain the second optical anisotropic element 75b but not to contain the first optical anisotropic element 75a. Furthermore, the second optical anisotropic element 75b may have such a size so as not to be contained in the remaining space of the first micro cup H1 in which the first optical anisotropic element 75a is contained.

The disposing process will be described in more detail with reference to FIGS. 7B and 7C.

Referring to FIG. 7B, the first optical anisotropic elements 75a having a large size are disposed in the first micro cups H1.

Then, a solution 75 containing the first optical anisotropic elements 75a formed in a micro-capsule or twist-ball shape is poured onto the substrate 71 from a container 76. At this time, since the second micro cups H2 have such a small size so as not to contain the first optical anisotropic elements 75a, the first optical anisotropic elements 75a are not contained in the second micro cups H2, but contained in the first micro cups H1, respectively.

Subsequently, referring to FIG. 7C, the second optical anisotropic elements 75b having a small size are disposed in the second micro cups H2, respectively.

Similar to the above-described process, a solution 75 containing the second optical anisotropic elements 75b is poured onto the substrate 71 from the container 76. At this time, when each of the second optical anisotropic elements 75b has such a size so as not be contained in the remaining space of a first micro cup H1 in which the first optical anisotropic element 75a is contained, the second optical anisotropic element 75 may be effectively contained in the second micro cup H2, not in the first micro cup H1.

The process of disposing balls having a different size in the micro cups may be performed by the simplified process without a mask or filter.

Next, the respective micro cups H1 and H2 are filled with a fluid such as oil. Then, referring to FIG. 7D, a display-side electrode 74 formed of a transparent electrode is provided to cover the top, thereby forming the electronic paper display device. The electronic paper manufactured by using balls or capsules having a different size according to the embodiment of the present invention may improve a packing factor as much as 10% or more in a single layer structure.

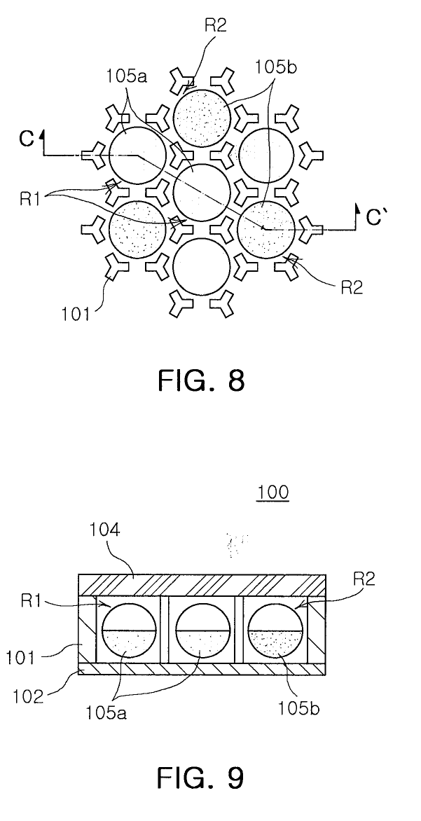

FIG. 8 is a top plan view of a substrate which may be adopted in an electronic paper display device according to another embodiment of the present invention. FIG. 9 is a side cross-sectional view of the electronic paper display device according to the embodiment of the present invention, taken along a line C-C′ of FIG. 8.

The electronic paper display device 100 according to the embodiment of the present invention includes a display-side electrode 104 disposed at a display side and formed of a transparent material, aback electrode 102 disposed to face the display-side electrode 104, and a plurality of embossed patterns 101 provided between the display-side electrode 104 and the back electrode 102.

Instead of the substrate structure having the micro cups formed therein which is adopted in the above-described embodiment, spaces for containing optical anisotropic elements are formed by arranging the plurality of embossed patterns 101. Such embossed patterns 101 are arranged as a single layer disposed between the display-side electrode 104 and the back electrode 102.

Referring to FIG. 8, first and second spaces R1 and R2 defined by the plurality of embossed patterns 101 are arranged in a two-dimensionally close-packed manner, and first and second optical anisotropic elements 105a and 105b are disposed in the first and second spaces R1 and R2, respectively. The plurality of first and second spaces R1 and R2 are arranged in a regular and repetitive manner.

Seen from the top, the embossed patterns 105 adopted in this embodiment are formed in such a Y shape that they may be easily partitioned. Furthermore, the embossed patterns 105 are arranged to provide hexagonal spaces. However, a plurality of embossed patterns having various shapes such as circle, triangle, straight line, and cross may be adopted. Furthermore, the plan shape of the space may be implemented in various manners.

Since the first and second optical anisotropic elements adopted in this embodiment have a different drive characteristic as in the above-described embodiment, the first and second optical anisotropic elements may be driven independently on the basis of their drive characteristics. In this case, since the first and second anisotropic elements are disposed in separate spaces, it is possible to prevent a problem caused by the contact with different optical anisotropic elements.

According to the embodiments of the present invention, the electronic paper display device having the monolayer-structure substrate, in which the optical anisotropic elements such as twist balls or electrophoretic capsules are arranged in a two-dimensionally close-packed manner, is manufactured to implement a high contrast ratio and a low driving voltage. As the balls or capsules serving as the optical anisotropic elements are separated from each other using the micro cups, the interaction between the respective balls and capsules may be reduced, making it possible to expect a smooth drive. Furthermore, as the anisotropic elements having a different size are disposed, it is possible to simplify the manufacturing process.

While the present invention has been shown and described in connection with the exemplary embodiments, it will be apparent to those skilled in the art that modifications and variations can be made without departing from the spirit and scope of the invention as defined by the appended claims.

What is claimed is:

1. An electronic paper display device comprising:
a display-side electrode disposed at a display side and formed of a transparent material;
a back electrode disposed to face the display-side electrode;
a substrate provided as a single layer disposed between the display-side electrode and the back electrode and comprising a plurality of first and second micro cups which are arranged in a two-dimensionally close-packed manner such that one micro cup is surrounded by different adjacent micro cups; and
a plurality of first and second optical anisotropic elements disposed in the first and second micro cups, respectively, and having an optical characteristic changing in response to an electromagnetic change and a different driving voltage to change the optical characteristic.

2. The electronic paper display device of claim 1, wherein the plurality of first and second micro cups have the same size and are arranged in a plurality of lines such that a predetermined distance is provided between the respective lines, and
the line arrangements of the first and second micro cups are alternately repeated in such a manner that the position of a first micro cup is offset by a distance equal to half of the cup size from the position of a second micro cup adjacent to the first micro cup.

3. The electronic paper display device of claim 1, wherein the plurality of first and second micro cups have a periodic square-lattice arrangement in which one micro cup is positioned substantially in the center of a square lattice formed by different adjacent micro cups.

4. The electronic paper display device of claim 3, wherein the second optical anisotropic element has a smaller size than the first optical anisotropic element.

5. The electronic paper display device of claim 4, wherein the second micro cup has a smaller size than the first micro cup.

6. The electronic paper display device of claim 5, wherein the depth of the second micro cup is less than that of the first micro cup.

7. The electronic paper display device of claim 4, wherein the second micro cup has such a small size so as not to contain the first optical anisotropic element.

8. An electronic paper display device comprising:
a display-side electrode disposed at a display side and formed of a transparent material;
a back electrode disposed to face the display-side electrode;
a plurality of embossed patterns disposed as a single layer disposed between the display-side electrode and the back electrode and arranged in a two-dimensionally close-packed manner to provide first and second spaces which are regularly repeated; and
a plurality of first and second optical anisotropic elements disposed in the first and second spaces, respectively, and having an optical characteristic changing in response to an electromagnetic change and a different driving voltage to change the optical characteristic.

9. A method of manufacturing an electronic paper display device, comprising:
forming a back electrode on a base member;
providing a substrate having a single layer structure on the back electrode;
forming a plurality of first and second micro cups in the substrate, the first and second micro cups being arranged in a two-dimensionally close-packed manner such that one micro cup is surrounded by different adjacent micro cups;
disposing first and second anisotropic elements in the first and second micro cups, respectively, the first and second anisotropic elements having an optical characteristic changing in response to an electromagnetic change and a different driving voltage to change the optical characteristic; and
forming a display-side electrode formed of a transparent material on the substrate such that the display-side electrode faces the back electrode.

10. The method of claim 9, wherein the plurality of first and second micro cups have the same size and are arranged in a plurality of lines such that a predetermined distance is provided between the respective lines, and
the line arrangements of the first and second micro cups are alternately repeated in such a manner that the position of a first micro cup is offset by a distance equal to half of the cup size from the position of a second micro cup adjacent to the first micro cup.

11. The method of claim 9, wherein the disposing of the first and second optical anisotropic elements comprises:
disposing the first optical anisotropic elements in the first micro cups using a first mask which opens only the first micro cups; and
disposing the second optical anisotropic elements in the second micro cups using a second mask which opens only the second micro cups.

12. The method of claim 9, wherein the plurality of first and second micro cups have a periodic square-lattice arrangement in which one micro cup is positioned substantially in the center of a square lattice formed by different adjacent micro cups.

13. The method of claim 12, wherein the second optical anisotropic element has a smaller size than the first optical anisotropic element.

14. The method of claim 13, wherein the second micro cup has a smaller size than the first micro cup.

15. The method of claim 14, wherein the depth of the second micro cup is less than that of the first micro cup.

16. The method of claim 14, wherein the second micro cup has such a small size so as not to contain the first optical anisotropic element.

17. The method of claim 16, wherein the disposing of the first and second optical anisotropic elements comprises:
providing the first optical anisotropic elements on the substrate to dispose in the first micro cups, respectively; and
providing the second optical anisotropic elements on the substrate to dispose in the second micro cups, respectively.
